(19) United States
(12) Patent Application Publication
(10) Pub. No.: US 2025/0257871 A1
(43) Pub. Date: Aug. 14, 2025

(54) System and Method for Performing Flame and Flow Field Diagnostics in a Combustor of a Gas Turbine Engine

(71) Applicant: RTX Corporation, Farmington, CT (US)

(72) Inventors: Joseph V. MANTESE, Ellington, CT (US); Gurkan GOK, Milford, CT (US); Stephen K. KRAMER, Cromwell, CT (US)

(21) Appl. No.: 18/908,030

(22) Filed: Oct. 7, 2024

Related U.S. Application Data
(60) Provisional application No. 63/588,379, filed on Oct. 6, 2023.

(51) Int. Cl. F23N 5/18

(52) U.S. Cl. CPC F23N 5/18; F23N 2005/185; F23N 2229/10; F23N 2241/20

(57) ABSTRACT

A combustor including: a combustor case defining a plurality of case apertures; a liner within the combustor case defining a combustion zone and liner apertures through which an airflow flows into the combustion zone; a fuel injector having a fuel channel extending through a first case aperture and the liner, and the fuel channel has a nozzle at the combustion zone through which fuel is injected; an igniter for igniting the combustible mixture of fuel and airflow and providing a flame at the nozzle; and a flame sensor including: a radio frequency transponder, comprising a transmitter-receiver pair, located exterior to the combustor case; a horn antenna disposed in the fuel nozzle, and a tubular waveguide extending from the radio frequency transponder to the horn via one of the plurality of case apertures, wherein the flame sensor is configured to perform flame and flow field diagnostics.

### CROSS-REFERENCE TO RELATED APPLICATIONS

This application claims the benefit of U.S. Application No. 63/588,379 filed Oct. 6, 2023, the disclosure of which is incorporated herein by reference in its entirety.

### BACKGROUND

Exemplary embodiments of the present disclosure pertain to the art of combustors of gas turbine engines and more specifically to a system and method for performing flame and flow field diagnostics in a combustor of a gas turbine engine.

A gas turbine engine requires the combustor to reliably produce a flame. Testing a flame production in a newly designed combustor and monitoring the flame production in an in-use combustor can help identify and correct issues that could otherwise lead to an inefficient operation of the engine.

### BRIEF DESCRIPTION

Disclosed is a combustor of a gas turbine engine, including: a combustor case defining a plurality of case apertures; a liner within the combustor case defining a combustion zone and liner apertures through which an airflow flows into the combustion zone; a fuel injector having a fuel channel extending through a first case aperture and the liner, and the fuel channel has a nozzle at the combustion zone through which fuel is injected, to produce a combustible mixture with the airflow; an igniter extending through a second case aperture and the liner for igniting the combustible mixture and providing a flame at the nozzle; and a flame sensor including: a radio frequency transponder, comprising a transmitter-receiver pair, located exterior to the combustor case; a horn antenna disposed in the fuel nozzle, and a tubular waveguide extending from the radio frequency transponder to the horn via one of the plurality of case apertures, wherein the flame sensor is configured to perform flame and flow field diagnostics.

In addition to one or more aspects of the combustor, or as an alternate, the flame sensor is configured to determine the presence of the flame.

In addition to one or more aspects of the combustor, or as an alternate, the flame sensor is configured to control a polarization of a transmission from the radio frequency transponder, to obtain data for a fluid dynamic analysis of a flow field of the fuel for imaging the flow field.

In addition to one or more aspects of the combustor, or as an alternate, the flame sensor is configured to control a waveform mode from the radio frequency transponder to provide for detecting different portions of the flame, to perform flame and flow field diagnostics in two or three dimensions.

In addition to one or more aspects of the combustor, or as an alternate, the flame sensor is configured to measure a reflective intensity of the flame to determine an intensity of combustion.

In addition to one or more aspects of the combustor, or as an alternate, the waveguide is one of: a transverse electromagnetic transmission line; a hollow tube; a dielectrically filled tube; and an air filled tube.

In addition to one or more aspects of the combustor, or as an alternate, the horn includes a lens formed of one or more of a dielectric and a metal.

Further disclosed is a gas turbine engine including: a combustor that includes: a combustor case defining a plurality of case apertures; a liner within the combustor case defining a combustion zone and liner apertures through which an airflow flows into the combustion zone; a fuel injector having a fuel channel extending through a first case aperture and the liner, and the fuel channel has a nozzle at the combustion zone through which fuel is injected, to produce a combustible mixture with the airflow; an igniter extending through a second case aperture and the liner for igniting the combustible mixture and providing a flame at the nozzle; and a flame sensor including: a radio frequency transponder, comprising a transmitter-receiver pair, located exterior to the combustor case; a horn disposed in the fuel nozzle, and a tubular waveguide extending from the radio frequency transponder to the horn via one of the plurality of case apertures, wherein the flame sensor is configured to perform flame and flow field diagnostics.

In addition to one or more aspects of the engine, or as an alternate, the flame sensor is configured to determine the presence of the flame.

In addition to one or more aspects of the engine, or as an alternate, the flame sensor is configured to control a polarization of a transmission, to obtain data for a fluid dynamic analysis of a flow field of the fuel for imaging the flow field.

In addition to one or more aspects of the engine, or as an alternate, the flame sensor is configured to control a waveform mode to provide for detecting different portions of the flame, whereby the flame sensor performs flame and flow field diagnostics in two or three dimensions.

In addition to one or more aspects of the engine, or as an alternate, the flame sensor is configured to measure a reflective intensity of the flame to determine an intensity of combustion.

In addition to one or more aspects of the engine, or as an alternate, the waveguide is one of: a transverse electromagnetic transmission line; a hollow tube; a dielectrically filled tube; and an air filled tube.

In addition to one or more aspects of the engine, or as an alternate, the horn includes a lens formed of one or more of a dielectric and a metal.

In addition to one or more aspects of the engine, or as an alternate, the engine includes: an inlet; a compressor downstream of the inlet; a turbine downstream of the compressor; and an exhaust downstream of the turbine, wherein the combustor is between the compressor and the turbine.

Further disclosed is a method of performing flame and flow field diagnostics in a combustor of a gas turbine engine, the method including: directing an airflow into a combustion zone of the combustor; directing fuel, via a fuel injector channel and a fuel nozzle, into the combustion zone to provide a combustion mixture with the airflow; igniting the combustion mixture to provide the flame; and performing flame and flow field diagnostics with a flame sensor via a radio frequency transponder comprising a transmitter-receiver pair, a horn in the fuel nozzle, and a tubular waveguide extending between the radio frequency transponder and the horn.

In addition to one or more aspects of the method, or as an alternate, the method includes determining with the flame sensor the presence of the flame.

In addition to one or more aspects of the method, or as an alternate, the method includes controlling a polarization of a transmission from the radio frequency transponder, to obtain data for a fluid dynamic analysis of a flow field of the fuel for imaging the flow field.

In addition to one or more aspects of the method, or as an alternate, the method includes controlling a waveform mode from the radio frequency transponder to provide for detecting different portions of the flame to perform flame and flow field diagnostics in two or three dimensions.

In addition to one or more aspects of the method, or as an alternate, the method includes measuring with the flame sensor a reflective intensity of the flame to determine an intensity of combustion.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2A shows details of a combustor configured for performing flame and flow field diagnostics in a combustor of a gas turbine engine, with a guide wire and horn antenna of the sensor in a first configuration;

FIG. 2B the combustor configuration of FIG. 2A, with the guide wire and horn antenna of the sensor in a second configuration;

FIG. 2C the combustor configuration of FIG. 2A, with the guide wire and horn antenna of the sensor in a third configuration; and

FIG. 3 is a flowchart showing a method of performing flame and flow field diagnostics in a combustor of a gas turbine engine.

### DETAILED DESCRIPTION

A detailed description of one or more embodiments of the disclosed apparatus and method are presented herein by way of exemplification and not limitation with reference to the Figures.

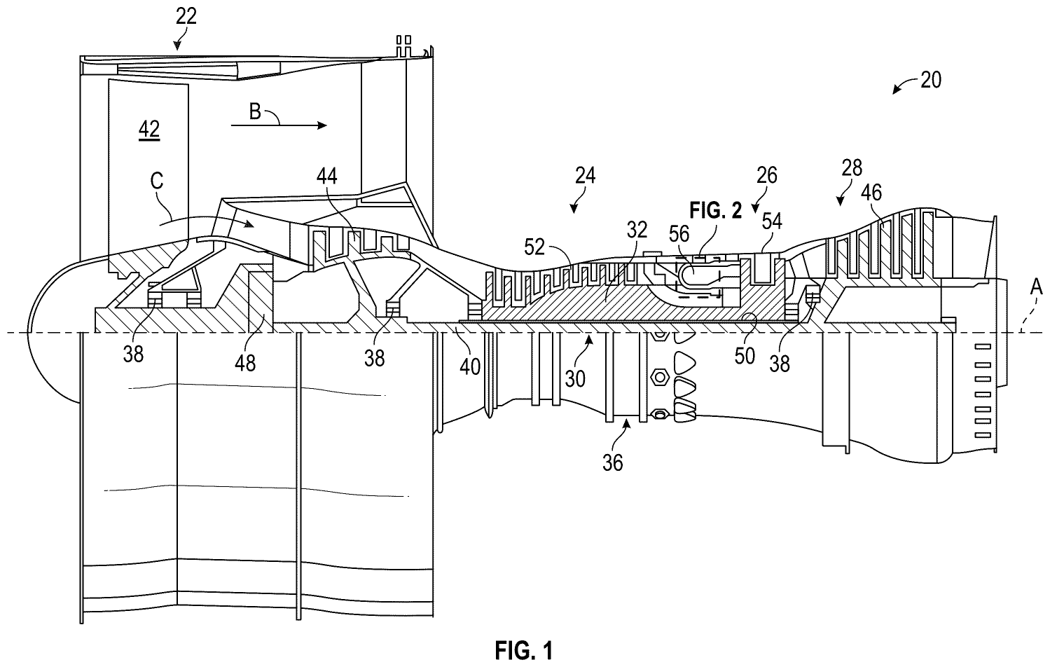

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. The geared architecture 48 may be an epicycle gear train, such as a planetary gear system or other gear system. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio.

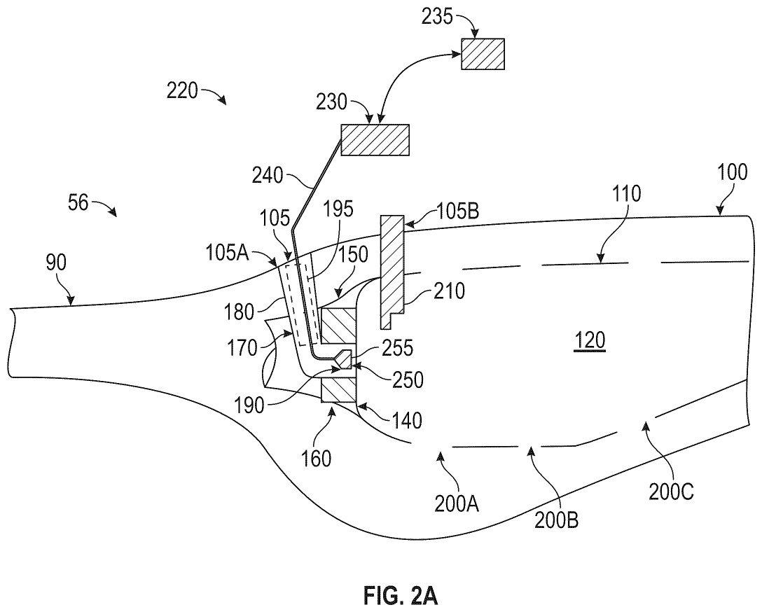

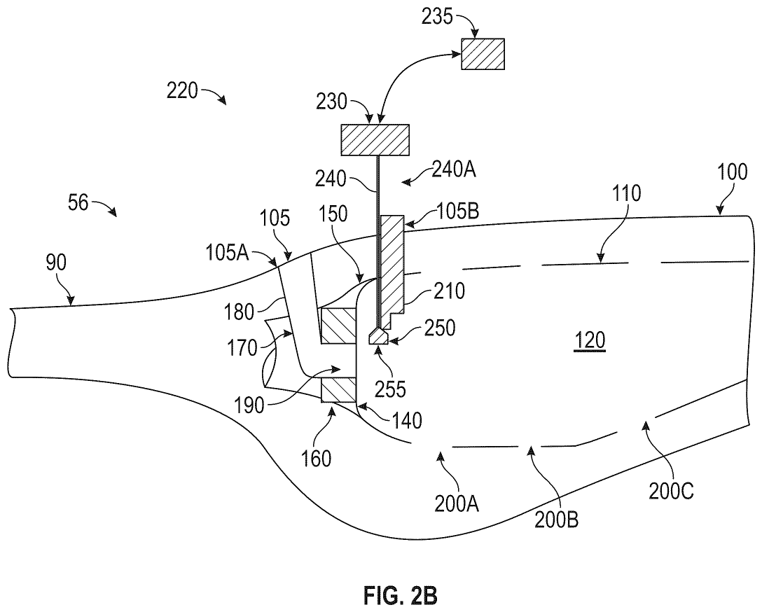

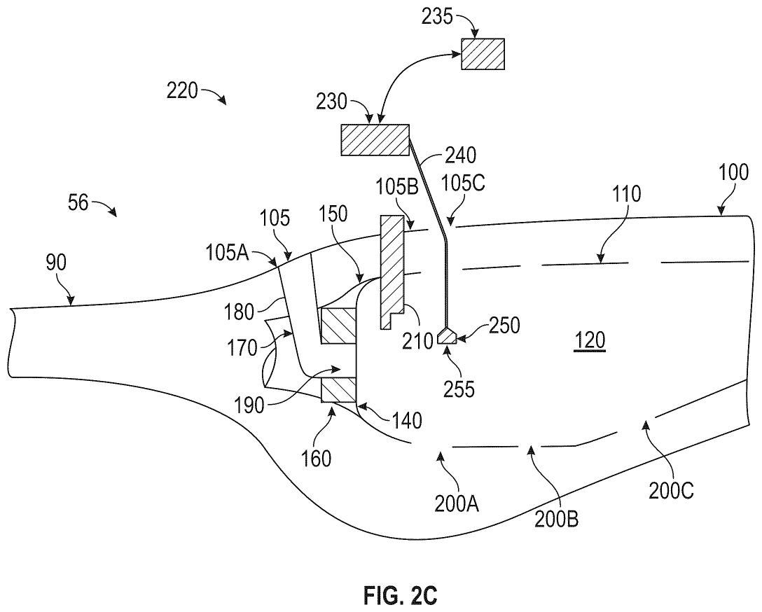

Turning to FIGS. 2A-2C, a diffuser 90 directs air to the combustor 56 from the high-pressure compressor 52. The combustor 56 includes a case 100 that defines a plurality of case apertures, generally reference as 105 and discussed in greater detail below. The diffuser 90 is located at a forward end of the combustor case 100. A liner 110 is within the case 100 and the liner 110 surrounds a combustion zone 120. The combustor 56 includes a dome 140 and a snout 150, which is an extension of the dome 140, and a swirler 160. The snout 150 is an air splitter, separating airflows from the diffuser 90.

The combustor 56 includes a fuel injector 170 having a fuel injector channel 180 that extends through a first case aperture 105A. The fuel channel 180 has a nozzle 190 (or opening) that opens into the combustion zone 120 via the dome 140. The nozzle 190 is surrounded by the swirler 160 and snout 150. Air flows through the dome 140 and swirler 160 as it enters the combustion zone 120 to mix with the fuel from the fuel injector 170 and form a combustible mixture. Liner apertures, generally referenced as 200, include for example three liner apertures 200A, 200B, 200C that direct air into the combustion zone 120 to cool and condition the combustion products. An igniter 210 extends thorough the case 100 via second case aperture 105B for igniting the combustible mixture and providing a flame.

According to an embodiment, a flame sensor 220 is provided. The flame sensor 220 includes a radio frequency (RF) transponder (for simplicity, a transponder) 230. The transponder 230 includes a transmitter-receiver pair. The transponder 230 is operationally coupled to a controller 235, which may be an engine controller or other controller. The transponder may operate in frequencies between the GHz to THz, and more specifically within the range 1 GHz and 140 GHz, in time partition transmission and reception, as discussed in greater detail below. A tubular waveguide 240 extends from the Transponder 230 to a microwave horn antenna (for simplicity, a horn) 250 in the nozzle 190 to sense conditions of the flame. In one embodiment, the waveguide 240 is a transverse electromagnetic transmission line, a hollow tube, a dielectrically filled tube or an air filled tube. In one embodiment, the horn 250 includes a lens 255 formed of one or more of a dielectric and a metal. Specifically, the waveguide 240 can be a tubular device, or can be a dielectric waveguide, or some combination.

The waveguide 240 may be provided in various configurations, e.g., along various paths, between the transponder 230 and the horn 250. In a first configuration of the waveguide 240 (FIG. 2A), the waveguide 240 may extend to the nozzle 190 via the first case aperture 105A, e.g., within the fuel channel 180. In one embodiment, a cavity 195 (schematically shown) is provided in and through the fuel nozzle 190 to accommodate the horn, one cavity for each fuel nozzle. With this configuration, performance of the fuel nozzles can be compared, e.g., by comparing an absolute and relative fuel nozzle to all the other fuel nozzles. This configuration would enable the use of feedback control on the fuel nozzles to improve pattern factor and thus improve engine performance.

In a second configuration of the waveguide 240 (FIG. 2B), the waveguide 240 may extend to the nozzle 190 via the second case aperture 105B, e.g., adjacent to the igniter 210. In a third configuration of the waveguide 240 (FIG. 2C), the waveguide 240 may extend to the nozzle 190 via a third case aperture 105C that is spaced apart from the first and second case apertures 105A, 105B.

That is, the waveguide 240 could be contained within the igniter 210, aligned along the length, which allows orthogonal imaging of the flame, allowing characterization of the entire flame front. Aligning the waveguide 240 along the nozzle 190 allows for lengthwise imaging and thus requires a smaller field of view and will be more compact. The different configurations of the waveguide 240 are not intended in limiting the configuration of the embodiments. It is to be appreciated that extending the waveguide through the first or second apertures 105A, 105B avoids having to form the third aperture 105C in the combustor case 100, which may be thermally efficient.

In one embodiment, the combustor 56 has a plurality of fuel injectors 170 with a corresponding plurality of fuel channels 180 and related nozzles 190. A plurality of the horns 250 may be provided, with one of the horns 250 being disposed in each of the nozzles 190. A corresponding plurality of waveguides 240 may extend from the same transponder 230, or optionally multiple transponders 230, to respective ones of the horns 250. The different waveguides may each couple with the respective horns 250 via one of the configurations (FIGS. 2A-2C) disclosed herein.

In one embodiment, the flame sensor 220 may be configured to control a transmission frequency from the Transponder 230. This enables determining one or more of a density, a mobility, and a temperature of the flame.

In one embodiment, the flame sensor 220 may be configured to control a polarization of the transmission from the Transponder 230. This enables obtaining data for a fluid dynamic analysis of the flow field of the fuel for imaging the flow field. This analysis enables, e.g., identifying when an impediment is within the fuel channel 180.

In one embodiment, the flame sensor 220 may be configured to control a waveform mode from the transponder 230. This provides for detecting different portions of the flame, to perform flame and flow field diagnostics in two or three dimensions.

In one embodiment, the flame sensor 220 may be configured to measure a reflective intensity of the flame. This enables the determination of an intensity of combustion.

As indicated, in one embodiment, a plurality of waveguides 240 are coupled between the transponder 230 and a plurality of horns 250 that are located in different ones of a plurality of the nozzles 190. In this embodiment, the flame sensor 220 may be configured to multiplex signals through the different waveguides 240. This enables performing flame and flow field diagnostics at each of the nozzles 190.

With the disclosed embodiments, the plasma nature of flames is exploited to diagnose the presence and quality of a flame emanating from combustion found in the combustor 56. Combustion creates a mixture a electrically conductive plasma that acts to reflect radio frequency waves similar to a sheet of metal. Electromagnetic radiation can be used to sense the presence or absence of a flame, thereby enabling a pattern factor determination for the flame.

The embodiments provide a radio frequency transmission and receiving transponder 230 operating at frequencies between the GHz to THz. The transponder 230 operating in this range creates radio frequency energy that impinges upon the flame, if it is present, with some portion of the incident energy reflected back, based on the volumetric extent of the flame. If the flame is not present, e.g., due to a blockage in the fuel channel 180, then the reflected signal is near zero, indicating a flame-out situation. By varying the frequency, polarization, directions by choice of mode shapes, and intensity of the electromagnetic radiation, the extent and intensity of the flame can be determined. As the detecting (or interrogation) can occur in nanoseconds, multiple flames from several of the nozzles 190 may be analyzed using the same flame sensor 220. Further, typically a forward signal and reflected signal may be characterized by the system scattering parameters (sometimes referred to as S parameters). However, the disclosed sensor 220 provides for other detection schemes including reflection coefficient schemes, standing wave ration schemes, as nonlimiting examples. For example, the value of S11, which indicates the backscattered radiation, will depend upon whether the flame is present and its spatial extent. It should be appreciated that a fully reflective surface has an S11 value of 0 dB, while a fully transmissive system has an S11 value of less than −50 bB or more, though these values are typically ideal and not obtained in practice.

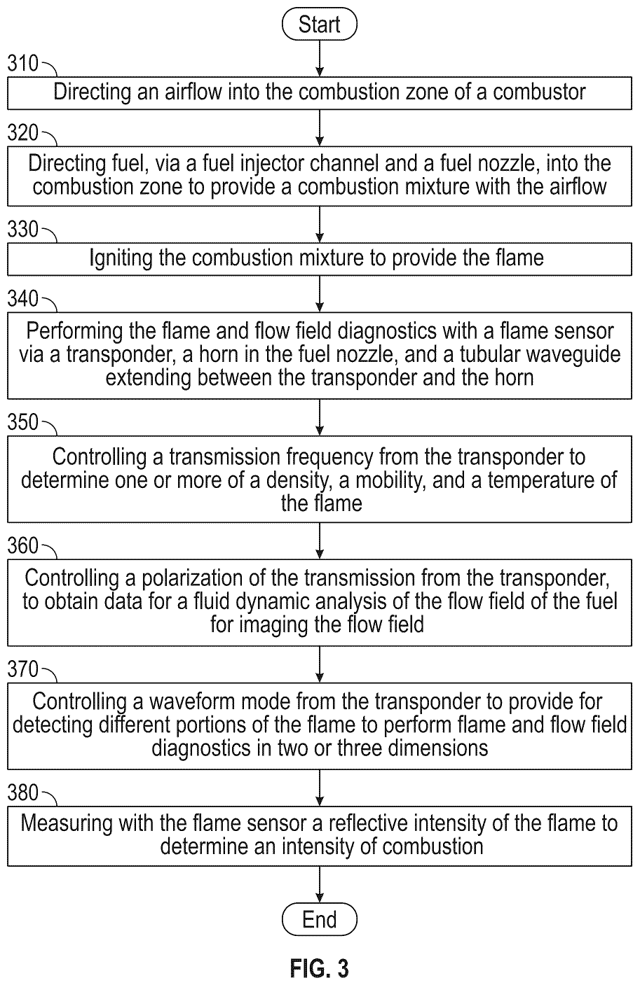

Turning to FIG. 3, a flowchart shows a method of performing flame and flow field diagnostics in a combustor of a gas turbine engine. As shown in block 310 the method includes directing an airflow into the combustion zone 120 of the combustor 56. As shown in block 320 the method includes directing fuel, via the fuel channel 180 and the fuel nozzle 190, into the combustion zone 120 to provide a combustion mixture with the airflow. As shown in block 330 the method includes igniting the combustion mixture to provide the flame.

As shown in block 340 the method includes performing flame and flow field diagnostics with a flame sensor 220 via the transponder 230, a horn 250 in the fuel nozzle 190, and a tubular waveguide 240 extending between the transponder 230 and the horn 250. As shown in block 350 the method includes controlling a transmission frequency from the transponder 220 to determine one or more of a density, a mobility, and a temperature of the flame. As shown in block 360 the method includes controlling a polarization of the transmission from the transponder 220, to obtain data for a fluid dynamic analysis of the flow field of the fuel for imaging the flow field. As shown in block 370, the method includes controlling a waveform mode from the transponder 220 to provide for the detecting of different portions of the flame to perform flame and flow field diagnostics in two or three dimensions. As shown in block 380 the method includes measuring with the flame sensor 220 a reflective intensity of the flame to determine an intensity of combustion. In other words, the flame sensor 220 can determine not only the presence of the flame, but provide diagnostics of it: intensity, spatial extent, temperature, % combustion, flow field dynamics, etc.

As indicated, the sensor 220 is configured for controlling output polarization. Selecting the electromagnetic polarization allows the impinging wave to determine the flow stream of the charge carriers and therefore allows both fluid dynamic analysis and the ability to image the flow fields. The sensor 220 is configured for controlling output frequency. By varying frequency, the sensor 220 can determine carrier density, mobility, and temperature of the flame, which is useful in understanding flame dynamics. The sensor 220 is configured for controlling an output mode. Mode shape allows the detecting of various portions of the flame, thereby enabling performing of flame and flow field diagnostics in two or three dimensions, e.g., to provide a flame shape. With the transponder 230, typically a forward signal and reflected signal are characterized by the system scattering parameters (sometimes referred to as S parameters). However, the sensor 220 provides for other detection schemes including reflection coefficient schemes, and standing wave ration schemes, as nonlimiting examples. The sensor 220 is configured for measuring reflective intensity. By measuring the reflected intensity, the sensor 220 can determine the degree of combustion.

With the use of the horn 250, the sensor 220 can be used as a point sensor for minimal diagnostics. The sensor 220 is configured for multiplexing. That is, a single or multiple transponders constituting a transmitter and receiver (Tx/Rx) can enable multi-burner detecting (or sensing), to reduce costs, size, weight, and power requirements of the sensor 220. The sensor 220 can operate in continuous wave (CW) or pulsed power with time allocations to sensing position of the flame and to allow the same waveguide 240 to be used to both send and receive diagnostic signals. The sensor 220 is configured for controlling the output frequency. The interrogation frequency of interest is from 1 GHz up to 1 THz, and more specifically within the range 10 GHz and 140 GHz. The waveguide 240 may include a stripline, it may be hollow, it may have a dielectric fill, air fill, it may be circular, rectangular, etc. The horn 250 also can be circular, rectangular, etc. The horn 250 can be optionally fitted with a lens 255, which can be made of dielectric, metal or the combination of metal and dielectric.

In sum, the embodiments utilize GHz to THz based radio frequency reflectometry to detect and image a flame to determine the pattern factor from a fuel nozzle 190. The embodiments provide for varying polarization, mode shape, frequency and phase of an incident radio frequency signal to spatially detect a combustor flame. The embodiments measure the reflected radiation from the flame in time partition transmission and reception. The embodiments use a radio frequency transponder 230 placed remote to the region of ignition, e.g., the combustion zone 120, with waveguided transmissions and reception. In addition, the utilization of a radio frequency solution enables the sensing to occur beyond line of sight, e.g., which might occur with an optical sensor solution.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A combustor of a gas turbine engine, comprising:
a combustor case defining a plurality of case apertures;
a liner within the combustor case defining a combustion zone and liner apertures through which an airflow flows into the combustion zone;
a fuel injector having a fuel channel extending through a first case aperture and the liner, and the fuel channel has a nozzle at the combustion zone through which fuel is injected, to produce a combustible mixture with the airflow;
an igniter extending through a second case aperture and the liner for igniting the combustible mixture and providing a flame at the nozzle; and
a flame sensor including: a radio frequency transponder, comprising a transmitter-receiver pair, located exterior to the combustor case; a horn antenna disposed in the fuel nozzle, and a tubular waveguide extending from the radio frequency transponder to the horn via one of the plurality of case apertures,
wherein the flame sensor is configured to perform flame and flow field diagnostics.

2. The combustor of claim 1, wherein:
the flame sensor is configured to determine the presence of the flame.

3. The combustor of claim 1, wherein:
the flame sensor is configured to control a polarization of a transmission from the radio frequency transponder, to obtain data for a fluid dynamic analysis of a flow field of the fuel for imaging the flow field.

4. The combustor of claim 1, wherein:
the flame sensor is configured to control a waveform mode from the radio frequency transponder to provide for detecting different portions of the flame, to perform flame and flow field diagnostics in two or three dimensions.

5. The combustor of claim 1, wherein:
the flame sensor is configured to measure a reflective intensity of the flame to determine an intensity of combustion.

6. The combustor of claim 1, wherein:
the waveguide is one of: a transverse electromagnetic transmission line; a hollow tube; a dielectrically filled tube; and an air filled tube.

7. The combustor of claim 1, wherein:
the horn includes a lens formed of one or more of a dielectric and a metal.

8. A gas turbine engine comprising:
a combustor that includes:
a combustor case defining a plurality of case apertures;
a liner within the combustor case defining a combustion zone and liner apertures through which an airflow flows into the combustion zone;
a fuel injector having a fuel channel extending through a first case aperture and the liner, and the fuel channel has a nozzle at the combustion zone through which fuel is injected, to produce a combustible mixture with the airflow;
an igniter extending through a second case aperture and the liner for igniting the combustible mixture and providing a flame at the nozzle; and
a flame sensor including: a radio frequency transponder, comprising a transmitter-receiver pair, located exterior to the combustor case; a horn disposed in the fuel nozzle, and a tubular waveguide extending from the radio frequency transponder to the horn via one of the plurality of case apertures,
wherein the flame sensor is configured to perform flame and flow field diagnostics.

9. The gas turbine engine of claim 8, wherein:
the flame sensor is configured to determine the presence of the flame.

10. The gas turbine engine of claim 8, wherein:
the flame sensor is configured to control a polarization of a transmission, to obtain data for a fluid dynamic analysis of a flow field of the fuel for imaging the flow field.

11. The gas turbine engine of claim 8, wherein:
the flame sensor is configured to control a waveform mode to provide for detecting different portions of the flame, whereby the flame sensor performs flame and flow field diagnostics in two or three dimensions.

12. The gas turbine engine of claim 8, wherein:
the flame sensor is configured to measure a reflective intensity of the flame to determine an intensity of combustion.

13. The gas turbine engine of claim 8, wherein:
the waveguide is one of: a transverse electromagnetic transmission line; a hollow tube; a dielectrically filled tube; and an air filled tube.

14. The gas turbine engine of claim 8, wherein:
the horn includes a lens formed of one or more of a dielectric and a metal.

15. The gas turbine engine of claim 8, further comprising:
an inlet;
a compressor downstream of the inlet;
a turbine downstream of the compressor; and
an exhaust downstream of the turbine,
wherein the combustor is between the compressor and the turbine.

16. A method of performing flame and flow field diagnostics in a combustor of a gas turbine engine, the method comprising:
directing an airflow into a combustion zone of the combustor;
directing fuel, via a fuel injector channel and a fuel nozzle, into the combustion zone to provide a combustion mixture with the airflow;
igniting the combustion mixture to provide the flame; and
performing flame and flow field diagnostics with a flame sensor via a radio frequency transponder comprising a transmitter-receiver pair, a horn in the fuel nozzle, and a tubular waveguide extending between the radio frequency transponder and the horn.

17. The method of claim 16, further comprising determining with the flame sensor the presence of the flame.

18. The method of claim 16, further comprising controlling a polarization of a transmission from the radio frequency transponder, to obtain data for a fluid dynamic analysis of a flow field of the fuel for imaging the flow field.

19. The method of claim 16, further comprising controlling a waveform mode from the radio frequency transponder to provide for detecting different portions of the flame to perform flame and flow field diagnostics in two or three dimensions.

20. The method of claim 16, further comprising measuring with the flame sensor a reflective intensity of the flame to determine an intensity of combustion.
